(19) United States
(12) Patent Application Publication
(10) Pub. No.: US 2026/0252337 A1
(43) Pub. Date: Aug. 27, 2026

(54) COMMAND TO OBTAIN FIRMWARE LEVEL DATA FOR ONE OR MORE NETWORK COMPONENTS

(71) Applicant: INTERNATIONAL BUSINESS MACHINES CORPORATION, Armonk, NY (US)

(72) Inventors: Pasquale A. Catalano, Wallkill, NY (US); John S. Werner, Fishkill, NY (US); Arkadiy O. Tsfasman, Wappingers Falls, NY (US); Andrew G. Crimmins, Montrose, NY (US)

(21) Appl. No.: 19/065,313

(22) Filed: Feb. 27, 2025

(51) Int. Cl. G06F 8/65

(52) U.S. Cl. CPC G06F 8/65

(57) ABSTRACT

A receiving network device obtains a command built to enable a control program of a device coupled to the receiving network device to obtain firmware level data of a network component. The command includes an indication of the network component for which the firmware level data is to be obtained. The receiving network device obtains the firmware level data of the network component indicated by the command and provides a response to the request for the firmware level data of the network component.

### BACKGROUND

One or more aspects relate, in general, to facilitating processing within a computing environment, and in particular, to facilitating communication within the computing environment.

Certain computing environments use networks, such as storage area networks and/or other networks, to provide access between devices. For example, a storage area network provides data paths between one or more host devices and one or more storage devices. The data paths may include network devices, such as switches, and/or other devices, as well as communication links. The links may be fiber optic or other types of cables or even wireless.

A device, such as a network device, has various components, including ports used to receive and/or transmit data (e.g., via optical transceivers), as well as other components. For example, a network device and/or a network, such as a storage area network, may include blades, such as server blades and/or other blades.

A server blade typically includes a single server, often dedicated to a single application, and includes, for instance, processors, memory, integrated network controllers, an optional host bus adapter (e.g., Fibre Channel host bus adapter) and other input/output ports. A server blade may be part of a blade server, which is a compact device that includes a computer used to manage and distribute data in a collection of computers and systems, such as a storage area network. A blade server includes, for instance, one or more thin, modular electronic circuit boards, known as server blades.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one device to perform computer operations. The computer operations include obtaining, by a receiving network device, a command built to enable a control program of a device coupled to the receiving network device to request firmware level data of a network component. The command includes an indication of the network component for which the firmware level data is requested. The computer operations further include obtaining, by the receiving network device, the firmware level data of the network component indicated by the command, and providing, by the receiving network device, a response to the request for the firmware level data of the network component.

Computer-implemented methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate, perform and/or use one or more aspects of the present disclosure;

FIG. 2 depicts one example of aspects of a storage area network to incorporate, perform and/or use one or more aspects of the present disclosure;

FIG. 3A depicts one example of the firmware level data code of FIG. 1, in accordance with one or more aspects of the present disclosure;

FIG. 3B depicts one example of command build/send code of the firmware level data code of FIG. 3A, in accordance with one or more aspects of the present disclosure;

FIG. 3C depicts one example of command receive/obtain code of the firmware level data code of FIG. 3A, in accordance with one or more aspects of the present disclosure;

FIG. 4 depicts one example of a command build/send process, in accordance with one or more aspects of the present disclosure;

FIG. 5A depicts one example of a control unit port command to obtain firmware level data, in accordance with one or more aspects of the present disclosure;

FIG. 5B depicts one example of information transmitted and/or received based on the control unit port command of FIG. 5A, in accordance with one or more aspects of the present disclosure;

FIG. 5C depicts one example of further details of firmware level data, in accordance with one or more aspects of the present disclosure; and

FIG. 6 depicts one example of a command receive/obtain process, in accordance with one or more aspects of the present disclosure.

### DETAILED DESCRIPTION

In accordance with one or more aspects of the present disclosure, a capability is provided to facilitate processing within a computing environment. In one aspect, the capability includes facilitating communication within the computing environment by improving the use of devices/components of a network, such as, for instance, a storage area network used to provide data paths between host devices and storage devices.

In one example, to improve utilization of devices of a storage area network (or other network), such as network devices (e.g., switches, directors, routers, appliances, etc.), of components of the network devices (e.g., ports that receive and/or transmit data, blades, fans, base chassis, units that hold the components, etc.), of links between the devices, of other devices of the storage area network, and/or of devices coupled to the storage area network, a capability is provided to obtain (e.g., gather, collect, determine, receive, extract, retrieve, etc.) firmware level data of one or more network components. A network component is a network device or a component of a network device, such as blades, fans, base chassis, units that hold the component, etc. ; and the firmware level data for a network component includes, for instance, release data of the network component. Examples of release data include one or more release identifiers, such as a release identifier for a major release, a release identifier for a sub-major release, a release identifier for a minor release and/or a release identifier for a patch release, and/or one or more release dates. This information is used by, for instance, a host device to learn, e.g., the releases and release dates related to one or more network components. Other examples are possible. The firmware level data is used, for example, to learn information about the network component, such as whether there are any security, access, failure and/or other concerns regarding the network component as indicated by the release data. This information is useful in, e.g., performing traffic routing through, e.g., a network (e.g., a storage area network). For instance, a network device associated with the network component and/or the network component may be bypassed; may be used less frequently; may be used at specific times of the day/month and/or year, as examples; may be replaced; may be updated; may be moved; etc. Other examples of firmware level data are possible, and there are many uses of the data. The example firmware level data and/or uses provided herein are just examples.

The obtaining of the firmware level data is performed based on, e.g., a command built and sent from one device, e.g., a host device, to another device, e.g., a receiving network device. The command is built by, using and/or on behalf of a control program (e.g., an operating system, other control program, etc.) of the one device to enable the control program to request firmware level data. The receiving network device receives the command and runs the command. It obtains the firmware level data, based on a command structure of the command. In one example, the receiving network device is part of a storage area network, and the device building/transmitting the command may be part of the storage area network or separate therefrom and coupled to the receiving network device, and optionally, one or more other devices of the storage area network.

As examples, the receiving network device obtains the firmware level data without using another network device and/or other device; and/or the receiving network device uses one or more other network devices (and/or other device(s), network component(s), etc.) to obtain the firmware level data. For instance, in one example, the receiving network device obtains (e.g., gathers, collects, determines, receives, extracts, retrieves, is provided, etc.) the firmware level data based on information accessible to the receiving network device; in another example, the receiving network device forwards at least an indication of the command to at least one other network device (and/or other device(s), network component(s), etc.) coupled to the receiving network device to obtain the firmware level data; in a further example, the receiving network device obtains firmware level data based on information accessible to the receiving network device and forwards at least an indication of the command to one or more other network devices (and/or other device(s), network component(s), etc.) to obtain firmware level data. Many possibilities exist.

As examples, the network component indicated in the command is the receiving network device and/or of the receiving network device; the network component indicated in the command is another network device and/or of the another network device; and/or multiple network components are indicated in the command, which may or may not include the receiving network device and/or be of the receiving network device. Various examples are possible. The receiving network device and the other network device(s) are part of a storage area network, in one example. The storage area network is coupled, in one example, to the device sending the command requesting the firmware level data. Other examples are possible.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., obtains firmware level data and/or performs one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

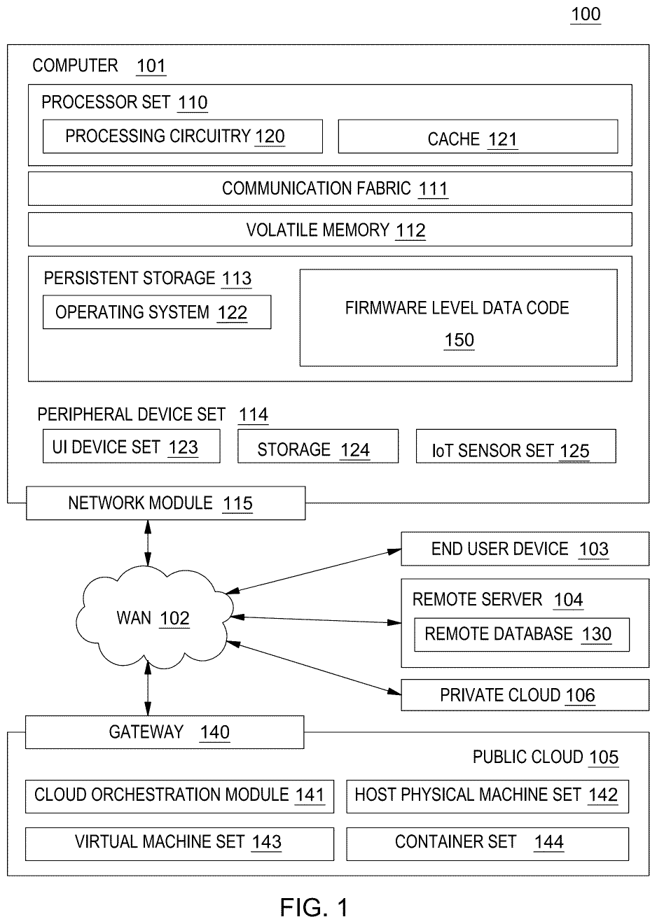

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as firmware level data code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

Further details relating to one or more components/modules/blocks of FIG. 1 used in accordance with one or more aspects of the present disclosure are described herein. For example, storage 124 is provided, in one example, by a storage network, such as a storage area network (SAN). In one example, a storage area network includes a plurality of devices coupled to one another via a plurality of connections. As examples, the plurality of devices includes one or more endpoint devices (e.g., one or more servers, such as computer(s) 101; one or more processors and/or nodes of a processor set (e.g., processor set 110); one or more remote servers, such as remote server(s) 104; and/or one or more end user devices, such as end user device(s) 103; etc.), one or more network devices (e.g., switches, directors, routers, appliances, etc.), one or more storage devices, and/or one or more other devices; and the connections include, for instance, links and/or other connections. Many examples are possible.

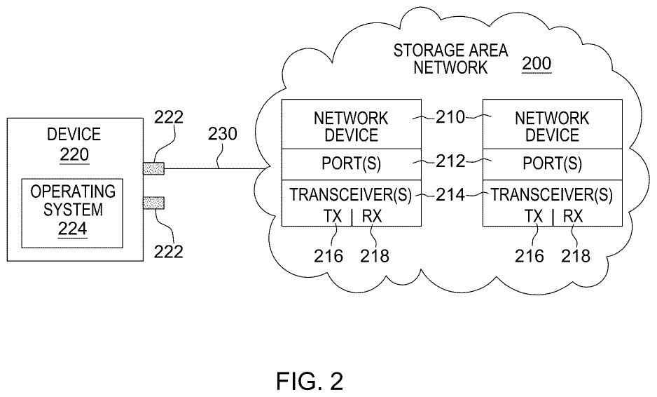

One example of network devices of a storage area network is described with reference to FIG. 2. In one example, a storage area network 200 includes one or more network devices 210, such as one or more switches, directors, routers, appliances, etc. As examples, one or more of network devices 210 support the Fibre Channel and/or Fibre Channel over Ethernet protocols. Although the Fibre Channel and/or Fibre Channel over Ethernet protocols are specified herein, one or more of the network devices may support other protocols. Fibre Channel and/or Fibre Channel over Ethernet protocols are just examples. Further, in one or more examples, storage area network 200 may be or include a network fabric, such as a switched fabric, which includes, for instance, a plurality of network devices (e.g., directors or switches based on fibre technology, other directors or switches and/or other network devices) coupled to one another via one or more connections (e.g., inter-switch links, other links and/or other connections). Various examples are possible.

Each network device 210 includes, for instance, one or more ports 212 that connect a network device to one or more other devices, including one or more other network devices and/or one or more other devices (referred to herein as non-network devices) via one or more links. A port (e.g., port 212) may receive and/or transmit data. In one example, a port (e.g., port 212) may include one or more transceivers (e.g., transceivers 214) to transmit (TX) 216 and/or receive (RX) 218 data. The transceivers may be, for instance, pluggable, optical transceivers that plug into the port(s).

In one example, one or more of network devices 210 is coupled to a device 220 via one or more links 230. As an example, the device is, e.g., a computer (e.g., computer 101, other computer, etc.), a server (e.g., server 104, other server, etc.), an end user device (e.g., end user device 103, other end user device, etc.), a processor, node and/or processing circuitry, etc. (e.g., of processor set 110 or other processor sets), other non-network device, and/or one or more other computing devices, etc. The device also includes, in one example, one or more ports 222 that connect the device to one or more network devices 210 and/or to other non-network devices. In one example, ports 222 of device 220 and/or of at least some other non-network devices (such as other endpoint devices, etc.) are referred to, in one example, as channel ports, while ports 212 of network device 210 are referred to, for instance, as switch ports. Other examples are possible.

In one example, device 220 is separate but coupled to the storage area network. In another example, it is part of the storage area network. In one example, device 220 includes an operating system (e.g., operating system 224) or another control program that sends commands from the device to, e.g., a network device coupled to the device. In one example, the device (e.g., device 220) is a host device. Other examples and/or variations are possible.

The storage area network of FIG. 2 is only one example. Storage area networks may include additional, fewer and/or other devices (e.g., network devices, non-network devices, etc.), ports and/or connections. Many examples and variations are possible. For instance, the number, type and interconnections of the devices and connections in each storage area network may be different. Further, storage area networks may support other transmission protocols. Again, many variations are possible.

In one example, to improve processing of and/or related to a storage area network (e.g., storage area network 200) and/or other networks, firmware level data (e.g., release identifiers and/or release date data) is obtained for one or more network components (e.g., network devices (e.g., switches, directors, routers, appliances, etc.), components of a network device (e.g., fans, blades, base chassis, units to hold components, etc.), etc.) of the storage area network.

In one or more aspects, the obtaining of firmware level data may be triggered based on, for instance, a command requesting firmware level data. In one or more aspects, the command may be built, transmitted and received using code, such as firmware level data code (e.g., firmware level data code 150 of FIG. 1), that includes code or instructions used to obtain firmware level data, in accordance with one or more aspects of the present disclosure.

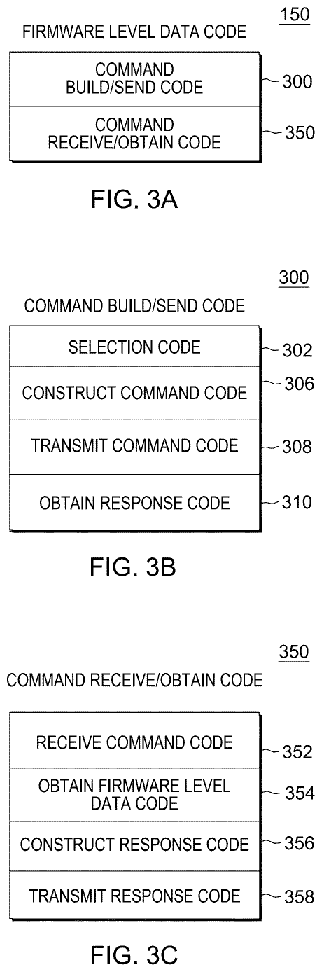

In one or more aspects, referring to FIG. 3A, firmware level data code (e.g., firmware level data code 150) includes, in one example, various code to be used to obtain firmware level data and/or to perform tasks relating thereto. The code is, e.g., computer-readable program code (e.g., instructions) in computer-readable media, e.g., storage (persistent storage 113, cache 121, storage 124, other storage, as examples). Although, as an example, firmware level data code 150 is depicted in FIG. 1 in persistent storage 113, the code and/or one or more portions of the code may be in other storage, such as storage 124, etc. Many variations are possible.

The computer-readable media may be part of one or more computer program products and the computer-readable program code may be executed by and/or using one or more devices (e.g., one or more computers, such as computer(s) 101; one or more servers, such as remote server(s) 104; one or more end user devices, such as end user device(s) 103; one or more processors or nodes, such as processor(s) or node(s) of processor set 110; processing circuitry, such as processing circuitry 120 of processor set 110; one or more network devices (e.g., networks devices 210 (FIG. 2)); and/or other devices, etc.). Additional and/or other computers, servers, end user devices, processors, nodes, processing circuitry, network devices and/or other devices may be used to execute the code and/or portions thereof. Many examples are possible.

One example of firmware level data code 150 includes, for instance, command build/send code 300 to be used to build a control unit port command to be used to obtain firmware level data and to send the command to a receiving device (e.g., a receiving network device); and command receive/obtain code 350 to be used to receive the command and obtain the requested firmware level data. Additional, less and/or other code may be used to implement the obtaining of firmware level data. Other variations are possible. Although various code is described, firmware level data code, such as firmware level data code 150, may include additional, less and/or different code. Particular code may include additional code, less code, and/or different code. Further, additional, less and/or other code may be used to obtain firmware level data and/or perform related tasks. Many variations are possible.

Further details relating to command build/send code 300 are described with reference to FIG. 3B and further details relating to command receive/obtain code 350 are described with reference to FIG. 3C. In one example, command build/send code 300 is executed on one or more non-network devices, such as device(s) 220, and command receive/obtain code 350 is executed on one or more network devices, such as network device(s) 210. In one example, a non-network device (e.g., non-network device 220) executing the command build/send code is coupled to, but separate and independent of a network device (e.g., network device 210) executing the command receive/obtain code. Other examples/variations are possible.

Referring to FIG. 3B, in one example, command build/send code 300 includes selection code 302 to be used to select one or more network components (e.g., network devices (e.g., switches, directors, routers, appliances, etc.), components of a network device (e.g., fans, blades, base chassis, units to hold components, etc.), etc.) for which firmware level data is to be obtained; construct command code 306 to be used to build a command, such as a control unit port command, to obtain firmware level data; transmit command code 308 to be used to send the built command (e.g., control unit port command) to a receiving device (e.g., a receiving network device 210); and obtain response code 310 to be used to obtain the firmware level data from the receiving network device and/or perform one or more tasks based on the received data. The command build/send code may include additional, less and/or other code. Other variations are possible.

Referring to FIG. 3C, in one example, command receive/obtain code 350 includes receive command code 352 to be used to receive the built command (e.g., control unit port command) at the receiving network device (e.g., a network device 210); obtain firmware level data code 354 to be used to obtain firmware level data of the indicated network components; construct response code 356 to be used to construct a response to the request for firmware level data; and transmit response code 358 to be used to transmit the constructed response to the transmitting device (e.g., operating system of the transmitting device; e.g., operating system 224). The command receive/obtain code may include additional, less and/or other code. Other variations are possible.

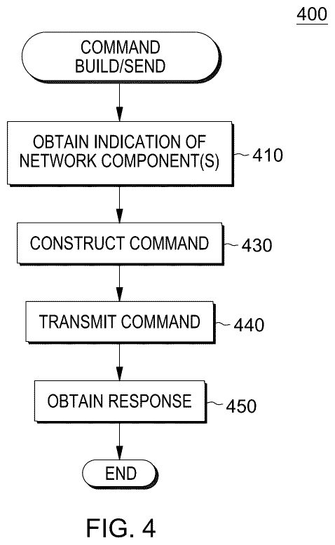

In one example, the command build/send code (e.g., command build/send code 300) is used, in accordance with one or more aspects of the present disclosure, to build a command and to transmit the command to obtain firmware level data and/or to perform other tasks related thereto, as further described with reference to FIG. 4. In one example, a command build/send process (e.g., a command build/send process 400) is implemented using one or more portions of firmware level data code 150 (e.g., code 300-310) and is executed by a device, such as device 220. In one example, device 220 is a computing device (e.g., a computer (e.g., computer 101, other computer, etc.), a server (e.g., server 104, other server, etc.), an end user device (e.g., end user device 103, other end user device, etc.), a processor, node and/or processing circuitry, etc. (e.g., of processor set 110 or other processor sets), other non-network device, and/or one or more other computing devices, etc.). Although example computers, servers, end user devices, processors, nodes, processing circuitry and/or computing devices are provided, additional, fewer and/or other computers, servers, end user devices, processors, nodes, processing circuitry and/or computing devices may be used for the command build/send process and/or other processing. Various options are possible.

In one example, one or more aspects of command build/send process 400 (also referred to as process 400) are implemented and/or executed by, on behalf of and/or using a control program (e.g., operating system 224), other control programs, and/or other operating systems executing on a device, such as device 220 and/or other non-network devices. The device (e.g., device 220) executing the control program (e.g., operating system 224) to build and send the command is coupled to, but separate from, a network device (e.g., network device 210) receiving the command and obtaining the requested firmware level data. In one example, the operating system (e.g., operating system 224) of the transmitting device (e.g., non-network device 220) is the z/OS® operating system offered by International Business Machines Corporation, Armonk, New York. The z/OS operating system, however, is only one example operating system; other operating systems of International Business Machines Corporation and/or of other entities/companies may include and/or use one or more aspects of the present disclosure. z/OS is a trademark or registered trademark of International Business Machines Corporation in at least one jurisdiction.

In one example, the command being built and transmitted is an architected command of a selected architecture. As an example, the selected architecture is the z/Architecture® instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. The z/Architecture instruction set architecture and the z/OS operating system are only examples and are not meant to be limiting in any way. z/Architecture and IBM are trademarks or registered trademarks of International Business Machines Corporation in at least one jurisdiction.

In one example, referring to FIG. 4, process 400 obtains 410 (e.g., using selection code 302) an indication of one or more network components (e.g., network devices (e.g., switches, directors, routers, appliances, etc.), components of a network device (e.g., fans, blades, base chassis, units to hold components, etc.), etc.) for which firmware level data (e.g., release data, such as release identifier(s) and/or release date data) is to be obtained. For example, one or more network components of interest are determined and provided to process 400. The selections may be performed by, for instance, a user at a device, such as device 220, via, e.g., an operating system (e.g., operating system 224) or the selections may be determined by the host (e.g., operating system) or other application, control program, etc. In one example, the control program (e.g., operating system 224) executing on the non-network device (e.g., non-network device 220) determines, based on information it possesses or obtains (e.g., input/output (I/O) configuration data, potential or actual I/O configuration changes, performance data, security concerns, other indications, etc.), that it would be beneficial to have firmware level data of selected network components of the storage area network. Other examples are possible.

The one or more network components selected may be selected periodically, randomly, based on a schedule, based on an I/O configuration change, based on a performance concern or a perceived performance concern, based on a security concern or a perceived security concern or for any other reason.

Process 400 constructs 430 a command (e.g., using construct command code 306), such as a control unit port command, to obtain firmware level data of one or more selected network components. For instance, the process (e.g., using the operating system) constructs the control unit port command using the selected network component information. In one example, it populates a command structure of the command, an example of which is described below, with, e.g., an identifier of the receiving network device, an identifier of the transmitting device and/or one or more identifiers of one or more network components for which firmware level data is to be obtained. Other examples are possible.

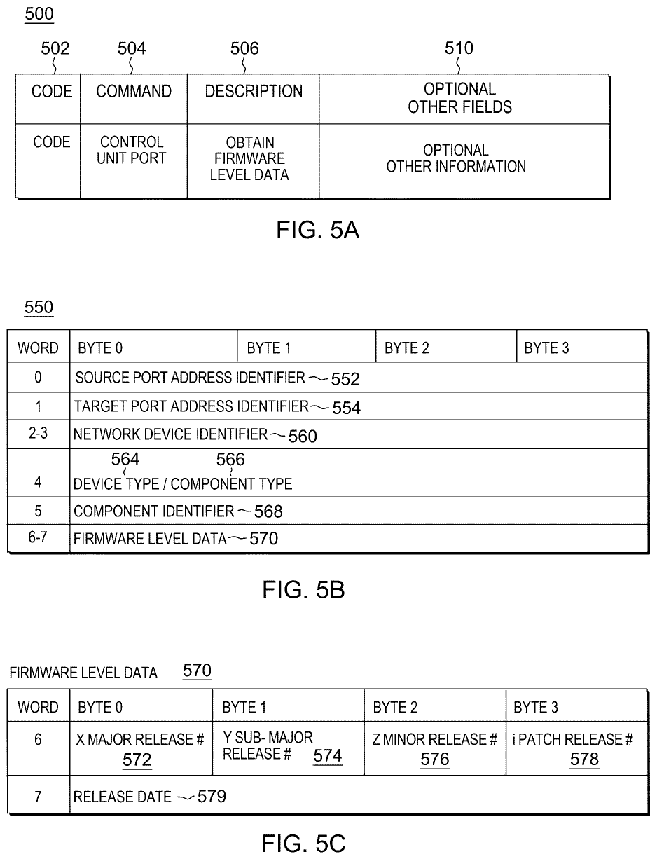

One example format of a command to be constructed is depicted in FIG. 5A. As shown, in one example, a command format 500 includes a code field 502, which includes a unique code identifying the command; a command field 504, which indicates the command, such as a control unit port command (and may or may not specify what action the command is performing); a description field 506, which provides a description of the command, such as obtain firmware level data; and optionally, there may be one or more other fields 510. As examples, the one or more other fields may include one or more of a test key and increment field, which indicates whether a test key and increment command with an equal test comparison is to be included in the same channel command word chain prior to this command; an identify field, which indicates whether an identify command is to be included in the same channel command word chain prior to this command; an accepted with host control prohibited field, which indicates whether this command will be accepted or not when host control is prohibited; and/or a count field, which indicates an amount of data to be transferred. Additional, fewer and/or other fields are possible. Other command formats are also possible. The command format may include additional, fewer and/or other fields/information. Many variations are possible.

One example of the information transferred and/or received using the control unit port command is described with reference to an example command structure depicted in FIG. 5B. In one example, a command structure 550 has one or more fields including information, such as, for instance:
Source Port Address Identifier 552 (e.g., bytes 0-2 of word 0): This field includes information regarding the port on the endpoint side. For instance, an identifier of the port used to transmit the command (e.g., a port of the transmitting device).
Target Port Address Identifier 554 (e.g., bytes 0-2 of word 1): This field includes information regarding the port on the target side. For instance, an identifier of the port used to receive the command (e.g., a port of the receiving network device).
Network Device Identifier 560 (e.g., words 2-3): This field includes an identifier of a network device (e.g., switch, director, router, appliance, etc.) for which firmware level data is being obtained. The firmware level data may be obtained for the network device itself or a component of the network device (e.g., fans, blades, base chassis, units to hold components, etc.), all of which are referred to herein as a network component.
Various types of identifiers may be used, and the identifiers may be of various sizes. Therefore, the number of bytes and/or words allocated in the command structure (e.g., command structure 550) depends on the type and/or size of the identifier. One example type of identifier is a World Wide Node Name (WWNN), which is, for instance, 8 bytes in size. However, other types of identifiers, other sizes of the WWNN and/or other identifiers, and/or various types of network devices may be specified. Many examples are possible.

In other examples, one or more network device identifiers may be specified using, e.g., bytes/words of the command structure. Many examples are possible.

In other examples, a network device identifier may not be specified if firmware level data for a network component other than a network device is to be obtained.

Device Type 564 (e.g., bits 0-1, byte 0 of word 4): This field includes, for instance, 2 bits to indicate the device type. For example, 00 Unknown; 01 Company A; 10 Company B; 11 Other. Many examples are possible.

In other examples, one or more device types may be specified using, e.g., bytes/words of the command structure. Many examples are possible.

Component Type 566 (e.g., bits 2-7, byte 0 of word 4): This field includes, for instance, an identifier of the component type. This field may be the other 6 bits of the device type field or its own 1-byte field, as examples. Example component types include, but are not limited to, fans, blades, base chassis, units to hold components, etc. Many examples are possible.

In other examples, one or more component types may be specified using, e.g., bytes/words of the command structure. Many examples are possible.

Component Identifier 568 (e.g., byte 0 of word 5): This field includes, for instance, a one-byte identifier of a component of a network device for which firmware level data is to be obtained. As an example each component of each component type has an identifier associated therewith and the identifier of the component of interest is indicated in this field. Many examples are possible.

In other examples, one or more component identifiers may be specified using, e.g., bytes/words of the command structure. In one or more examples, a component identifier may not be specified if the firmware level data is to be obtained for the network device itself. Many examples are possible.

Firmware Level Data 570 (e.g., words 6-7): This field includes, for instance, selected firmware level data of a selected network component. If more than one network component is indicated, additional bytes/words may be used to store the firmware level data. Many examples are possible.

Further details regarding the firmware level data (e.g., firmware level data 570) are described with reference to FIG. 5C. In one example, a firmware level for the identified network component is specified as: X.Y.Z. i, each of which is described below. For instance, firmware level data 570 includes:
X Major Release Number (#) 572 (e.g., byte 0, word 6): This field includes, for instance, a release identifier (e.g., number) for a major release for the network component. Other examples are possible.
Y Sub-Major Release Number (#) 574 (e.g., byte 1, word 6): This field includes, for instance, a release identifier (e.g., number) for a sub-major release for the network component. Other examples are possible.
Z Minor Release Number (#) 576 (e.g., byte 2, word 6): This field includes, for instance, a release identifier (e.g., number) for a minor release for the network component. Other examples are possible.
i Patch Release Number (#) 578 (e.g., byte 3, word 6): This field includes, for instance, a release identifier (e.g., alpha-numeric value) for a patch release for the network component. Other examples are possible.

Release Date 579 (e.g., bytes 0-3, word 7): This field includes, for instance, a release date for the indicated release for the network component. Other examples are possible.

If there is more than one network component specified, then there may be additional firmware level data provided in the same bytes and/or one or more additional bytes within the structure. Further, the firmware level for a network component may include additional, less and/or other data. Many examples are possible.

In one or more aspects, the command structure may include additional, less and/or other fields and/or information. Many examples are possible.

Although in the example information described herein, specific words/bytes/bits are indicated for the fields, other words/bytes/bits may be used for the specific fields. Further, although the words/bytes/bits are set to specific values for one purpose or another, the words/bytes/bits may be set to the opposite values and/or different values. The particular words/bytes/bits and/or values described herein are just examples. Moreover, other example information and/or command structures may include additional, fewer, and/or other fields. In one or more embodiments, one or more of the fields may include an indicator (e.g., a bit) to be used to indicate whether that particular data of the field is to be populated/returned. In other examples, it is assumed that the data of the fields is to be populated/returned. Further, one or more fields may be ignored, left blank and/or not included in the command structure. Many variations and examples are possible.

Returning to FIG. 4, process 400 transmits 440 the built command (e.g., using transmit command code 308) to a receiving device. For instance, process 400 transmits the command from, e.g., the operating system (e.g., operating system 224) to a selected receiving network device (e.g., a selected network device 210 (e.g., a switch, director, router, appliance, etc.)) using, e.g., a local port (e.g., a port 222) and one or more links (e.g., links 230). The receiving network device receives the command (e.g., using a port (e.g., a port 212)) and based on the command, obtains the firmware level data for the one or more network components identified in the command. As examples, the receiving network device determines the data itself and/or uses other devices (e.g., other network devices and/or other devices) and/or components of the storage area network to obtain the requested firmware level data. The receiving network device prepares a response that includes the requested firmware level data and forwards the response to the transmitting device (e.g., device 220). Various examples are possible.

In one example, process 400 obtains 450 a response (e.g., using obtain response code 310) based on the requested firmware level data. As an example, the response includes the command structure (e.g., command structure 550) with the requested data. Other examples are possible.

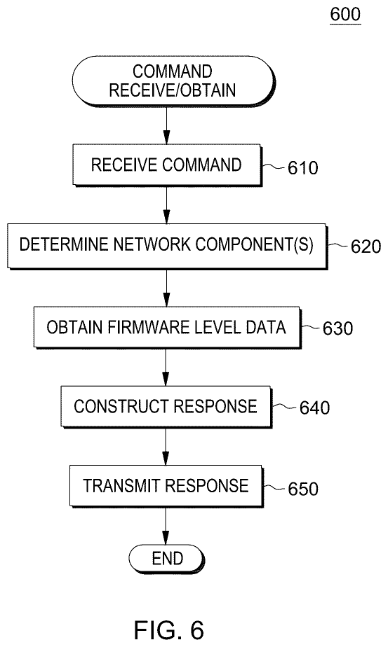

Further details relating to processing by the receiving network device are described with reference to FIG. 6. In one example, the constructed command is received at the receiving device (e.g., a receiving network device 210 identified by, e.g., target port address identifier 554) in order to obtain firmware level data of one or more network components. In one example, code of firmware level data code 150 is used, in accordance with one or more aspects of the present disclosure, to receive the command, obtain the firmware level data and/or perform other tasks related thereto, as described with reference to FIG. 6. In one example, a command receive/obtain process (e.g., a command receive/obtain process 600) is implemented using code 350-358 and is executed by one or more devices, such as one or more network devices 210, as described herein. In one example, network device 210 includes a switch, a director, a router, an appliance and/or another network device. A network device may have processing circuitry. In other examples, other devices, other than network devices, may also receive an obtain firmware level data command and/or perform one or more actions to obtain the data. In one example, the network device receiving the command may obtain the data of one or more identified network components and/or send the command, or an indication of the command, to one or more other network devices (and/or other devices and/or components) to obtain the firmware level data of one or more network components. Various options and examples are possible.

In one example, process 600 executing on a device (e.g., network device 210) receives 610 the command (e.g., using receive command code 352) and determines 620 the one or more network components for which firmware level data is to be obtained. For instance, process 600 obtains an indication of the one or more network components from one or more fields of the command structure (e.g., command structure 550).

Further, process 600 obtains (e.g., gathers, collects, receives, determines, is provided, extracts, retrieves, etc.) 630 the firmware level data (e.g., using obtain firmware level data code 354) for the one or more network components indicated in the command. In one example, the receiving network device obtains the firmware level data (e.g., release data, such as one or more release identifiers and/or release dates) from the network components(s) indicated in the command, which may be itself and/or one or more other network components. A network component, in one example, extracts the information which is stored at the network component and/or in a location accessible to the network component. If the network component is not the receiving network device, the network component provides that information to the receiving network device based on a request of the receiving network device. For instance, it provides the information based on receiving at least an indication of the command from the receiving network device. In another example, the receiving network device obtains the firmware level data of the one or more indicated network components from one or more other devices and/or components within and/or coupled to the storage area network. In a further example, if the network component is not the network device, but instead, a component (e.g., fan, blade, chasis, unit to hold the component, etc.) of the network device, then the network device may obtain the information for the component (e.g., from the component and/or from another location storing the information). Many examples are possible.

In one example, based on obtaining the requested firmware level data, process 600 constructs 640 a response (e.g., using construct response code 356). This includes, for instance, entering the data in the command structure. For instance, process 600 populates the field(s) storing firmware level data 570 (e.g., X major release number 572, Y sub-major release number 574, Z minor release number 576, i patch release number 578 and/or release date 579) with the obtained firmware level data. Further, in one or more embodiments, process 600 may populate and/or update one or more other fields. Other examples are possible.

Further, the response is transmitted 650 (e.g., using transmit response code 358) to the transmitting device, which is identified, for instance, by source port address identifier 552 of command structure 550. Other examples are possible.

In one example, the control program (e.g., operating system 224) of the transmitting device receives the response and may take action based on the response. For instance, it may make routing decisions based thereon, enable/disable selected network devices, remove a network component from use, add a network component, update a network component, adjust a routing path, etc. The action taken depends, for instance, on the received firmware level data and a determination of an approach to be implemented to, e.g., improve the network (e.g., storage area network) to facilitate communication and/or processing within the computing environment. Many variations are possible.

In one or more aspects, a capability is provided to build a command, such as a control unit port command, and send the command to a network device (or other device) of, e.g., a storage area network (or other network) to obtain firmware level data of one or more one or more network components of, e.g., a storage area network. This enables another device, such as an operating system executing on the other device, to request firmware level data, which may be used to improve component operations, communications and processing within a computing environment.

In one example, the operating system (e.g., operating system 224) is afforded the ability to use a structured command, architecturally defined, to request firmware level data of one or more network components coupled thereto. The request by the operating system may be programmatically sent based on information possessed, obtained, determined, perceived, etc. at the operating system side (i.e., not the network device side). In one or more aspects, it provides the operating system with an ability, previously not afforded, to obtain firmware level data from a network component. It enables the operating system to extract information about the firmware level of a network component to identify any concerns, e.g., security vulnerabilities, etc.

As an example, the command is built and sent by the operating system executing on a non-network device based on I/O configuration data, such as access to an I/O configuration data set, other I/O configuration information, performance data (e.g., related to data transmission, etc.), security concerns, information obtained, etc. It allows one tool (e.g., the operating system) to have control of the information to be requested and when to request it. It allows the operating system to take action prior and/or subsequent to receiving the data since it has control of when to request the data and/or the data to be requested. It provides the computing environment on which the operating system executes (e.g., the mainframe, etc.) to now have visibility into the firmware level data, including, for instance, release identifiers and/or release date. Many examples are possible.

Previously, particular systems were not able to extract information about the firmware level of a storage area network device to which they were connected. Clients who own a particular system box may not own all their switches, as an example. If they use, for instance, third party telecom companies, they are unable to log into the storage area network switches directly to extract firmware information. This can lead to security concerns for data routed through the switch if a known vulnerability exists on the storage area network device that was not patched or updated. Thus, in accordance with one or more aspects, the particular systems previously unable to obtain the firmware information, are now able to send a command (e.g., an architected command) to obtain the information.

In one example, implementation and use of the command to request the firmware level data from network components does not depend on or require knowledge of the specific vendor(s) of the network components (e.g., of the storage area network) or of the original equipment manufacturer's management software (or others) used by the network components. The command is not network component/device-or storage area network-vendor specific, allowing the command to be used by the operating system for network components offered by various vendors.

One or more aspects of the present disclosure are tied to computer technology and facilitate processing within a computer, improving performance thereof. For instance, communication within a computing environment is improved by providing a capability to obtain firmware level data of one or more network components of, e.g., a storage area network. A capability is provided for the coupled host device to, for instance, request from one or more storage area network components firmware level data of one or more network components within a storage area network. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet as a further aspect, a process for integrating computing infrastructure comprising integrating computer-readable code into a computer system may be provided. The computer system comprises a computer-readable medium, in which the computer-readable medium comprises one or more embodiments. The code in combination with the computer system is capable of performing one or more embodiments.

Although various embodiments are described above, these are only examples. For example, other techniques to request firmware level data may be used. Further, services and/or commands may be used to obtain the data, e.g., firmware level data. Moreover, additional, less and/or other information may be transmitted/populated using the control unit port command to obtain firmware level data. Yet further, networks other than storage area networks may use one or more aspects of the present disclosure. Further, the storage area network may be separate and/or different from storage 124. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one device to perform computer operations including:
obtaining, by a receiving network device, a command built to enable a control program of a device coupled to the receiving network device to request firmware level data of a network component, the command including an indication of the network component for which the firmware level data is to be obtained;
obtaining, by the receiving network device, the firmware level data of the network component indicated by the command; and
providing, by the receiving network device, a response to the request for the firmware level data of the network component.

2. The computer program product of claim 1, wherein the network component is a network device of a storage area network.

3. The computer program product of claim 1, wherein the network component is a component of a network device of a storage area network.

4. The computer program product of claim 1, wherein the firmware level data includes release data of the network component.

5. The computer program product of claim 4, wherein the release data includes at least one release identifier for the network component.

6. The computer program product of claim 5, wherein the at least one release identifier includes one or more identifiers selected from a group of identifiers consisting of: a major release identifier, a sub-major release identifier, a minor release identifier and a patch release identifier.

7. The computer program product of claim 4, wherein the release data includes at least one release date for the network component.

8. The computer program product of claim 1, wherein the obtaining the firmware level data includes forwarding at least an indication of the command to at least one network device coupled to the receiving network device to obtain the firmware level data of the network component.

9. The computer program product of claim 1, wherein the command is a control unit port command constructed based on a defined format and uses a command structure built to be used with the command, the command structure provided to the receiving network device and including the indication of the network component for which the firmware level data is to be obtained and one or more fields to include the firmware level data of the network component.

10. The computer program product of claim 1, wherein the receiving network device is a same device as the network component.

11. The computer program product of claim 1, wherein the receiving network device is a different device than the network component.

12. The computer program product of claim 1, wherein the command includes a plurality of indications of a plurality of network components for which firmware level data is to be obtained.

13. A computer system comprising:
at least one device;
a set of one or more computer-readable storage media; and
program instructions, collectively stored in the set of one or more computer-readable storage media, for causing the at least one device to perform computer operations including:
obtaining, by a receiving network device, a command built to enable a control program of a device coupled to the receiving network device to request firmware level data of a network component, the command including an indication of the network component for which the firmware level data is to be obtained;
obtaining, by the receiving network device, the firmware level data of the network component indicated by the command; and
providing, by the receiving network device, a response to the request for the firmware level data of the network component.

14. The computer system of claim 13, wherein the firmware level data includes release data of the network component.

15. The computer system of claim 14, wherein the release data includes at least one release identifier for the network component and at least one release date for the network component.

16. The computer system of claim 13, wherein the command includes a plurality of indications of a plurality of network components for which firmware level data is to be obtained.

17. A computer-implemented method of facilitating processing within a computing environment, the computer-implemented method comprising:
obtaining, by a receiving network device, a command built to enable a control program of a device coupled to the receiving network device to request firmware level data of a network component, the command including an indication of the network component for which the firmware level data is to be obtained;
obtaining, by the receiving network device, the firmware level data of the network component indicated by the command; and
providing, by the receiving network device, a response to the request for the firmware level data of the network component.

18. The computer-implemented method of claim 17, wherein the firmware level data includes release data of the network component.

19. The computer-implemented method of claim 18, wherein the release data includes at least one release identifier for the network component and at least one release date for the network component.

20. The computer-implemented method of claim 17, wherein the command includes a plurality of indications of a plurality of network components for which firmware level data is to be obtained.
